(19) United States
(12) Patent Application Publication
(10) Pub. No.: US 2008/0094380 A1
(43) Pub. Date: Apr. 24, 2008

(54) Electronic Device With Multiple Array Devices

(75) Inventors: Martin J. Edwards, Crawley (GB); John R.A. Ayres, Reigate (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,395

(22) PCT Filed: May 19, 2005
(86) PCT No.: PCT/IB05/51626

§ 371 Date: Nov. 20, 2006

(30) Foreign Application Priority Data
May 21, 2004 (GB) 0411314.8

(51) Int. Cl. G09G 5/00; G09G 3/36

(52) U.S. Cl. 345/205; 345/87

(57) ABSTRACT

An electronic device has a first active matrix pixel array device (52) and a second pixel array device (54). The first and second pixel arrays are provided on separate substrates (56,58), and a part (62) of the addressing or processing circuitry of the first active matrix array device (52) is provided on the substrate (58) of the second pixel array. The invention provides the distribution of control circuitry between two substrates (56,58) in a device having two array devices (52,54). This can enable the costs associated with a defect in the row and column driver circuitry to be minimised.

The invention relates to electronic devices which have a plurality of array devices, for example multiple active matrix displays.

Active matrix liquid crystal displays (AMLCDs) are one well known example of array device. In such displays, an active plate and a passive plate sandwich a liquid crystal. The active plate includes a number of electrodes for applying electric fields to the liquid crystal and the electrodes are generally arranged in an array. Row and column electrodes extend along the rows and columns of pixel electrodes and drive thin film transistors which drive respective pixel electrodes.

The row and column electrodes are driven to control the thin film transistors to control the charge stored on corresponding pixel electrodes. Each pixel typically includes a capacitor for maintaining charge on the pixel.

One difficulty is in providing the necessary circuits for decoding incoming signals and driving the row and column electrodes. Generally, such driver circuits have been arranged around the outside of the pixel array, in the form of dedicated integrated circuits.

There is currently much interest in the use of low temperature polysilicon (LTPS) to integrate some of the functions of a driver IC onto the glass of an AMLCD (or other active matrix display device). Integration helps save some of the IC cost and can also make the display more compact, more reliable and can also simplify assembly. For example, one of the functions which it is desirable to integrate is the digital to analogue converters (DACs) used to convert digital input data into the analogue voltage required to fix the transmission of an LC pixel.

However, as the complexity of the integrated circuits increases, the yield of the complete array device is reduced, as a defect in one part of the circuitry can require the complete device substrate to be discarded, resulting in increased production costs.

According to the invention there is provided an electronic device, comprising:

a first array device comprising a first pixel array of rows and columns of pixels, and circuitry for providing and/or processing signals associated with the rows and/or columns of pixels; and

a second array device comprising a second pixel array,

wherein the first and second pixel arrays are provided on separate substrates, wherein a part of the circuitry of the first array device is provided on the substrate of the second pixel array, and wherein the first and second pixel arrays are independently controlled.

The invention provides the distribution of control/processing circuitry between two substrates in a device having two array devices. This can enable the costs associated with a defect in the circuitry to be minimised. These costs may arise through waste of materials as well as less efficient use of production capability. The first array device is preferably an active matrix array device.

The two array devices are independently controlled, which means that the output for the two devices may be selected independently. For example, two displays may be provided with independently controlled output images. Alternatively, they may be different types of device, so that the control of the two devices is by means of completely different control signals. In each case, the provision of part of the circuitry for providing and/or processing signals of one pixel array on the substrate of the other pixel array does not compromise the functionality of either array device. Both devices may be output devices, or one may be an output device and one may be an input device.

Preferably, the second array device is of lower cost than the first, for example it may be lower resolution or it may be black and white instead of colour. It may also (or instead) be smaller than the first array device.

The first array device preferably comprises an active matrix display, for example a liquid crystal display. The second array device may comprise a display, an image sensor device or a touch sensing device, such as a fingerprint sensor.

The part of the circuitry of the first array device may comprise digital to analogue converter circuits, charge pump circuits, control or timing circuits and/or memory circuit elements. The circuitry of the first array device which is provided on the other substrate is preferably selected so that the required number of interconnections to the first substrate does not need to be increased. For example, latching circuits or multiplexing circuitry may remain on the substrate of the first array device.

One or both of the first and second pixel arrays may be formed using a low temperature polysilicon process, which is suitable for the integration of IC functions. In one example, the first pixel array is formed using an amorphous silicon process (and which is less suitable for the formation of integrated circuit components) and the second pixel array is formed using a low temperature polysilicon process. In this way, a technology with improved TFT characteristics is used for the substrate carrying the more complex circuitry, even though this is the substrate carrying the array device with the lower performance requirements. More generally, the two arrays may be formed with different processing parameters or technologies.

The invention also provides a method of driving a first pixel array device, the first pixel array device being provided on a first substrate, the method comprising:

generating control signals for the pixels of the first pixel array device;

processing the control signals using circuitry provided on a substrate which carries a second pixel array device;

providing the processed control signals to the substrate of the first array device; and

controlling the pixels of the first pixel array device using the processed control signals independently of the control of the second pixel array device.

For a better understanding of the invention, embodiments will now be described, purely by way of example, with reference to the accompanying drawings in which:

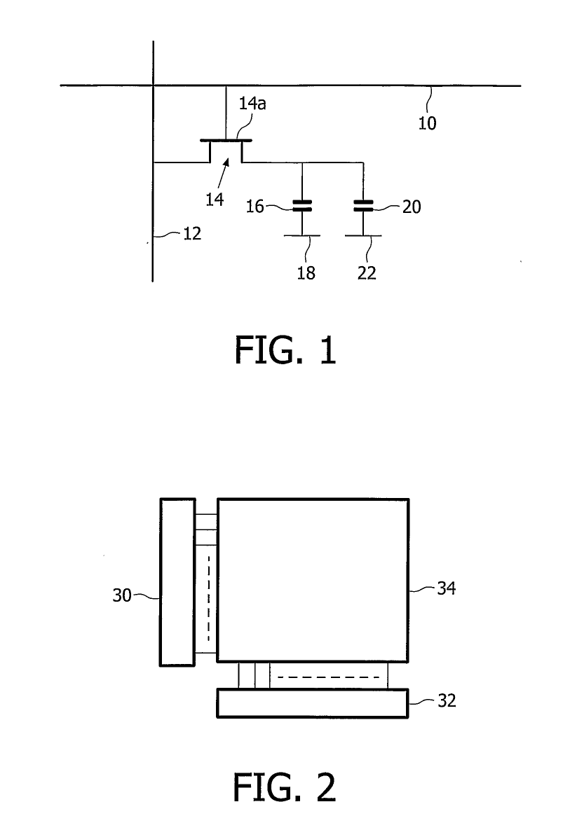

FIG. 1 shows a known liquid crystal pixel circuit;

FIG. 2 shows the general components of a liquid crystal display;

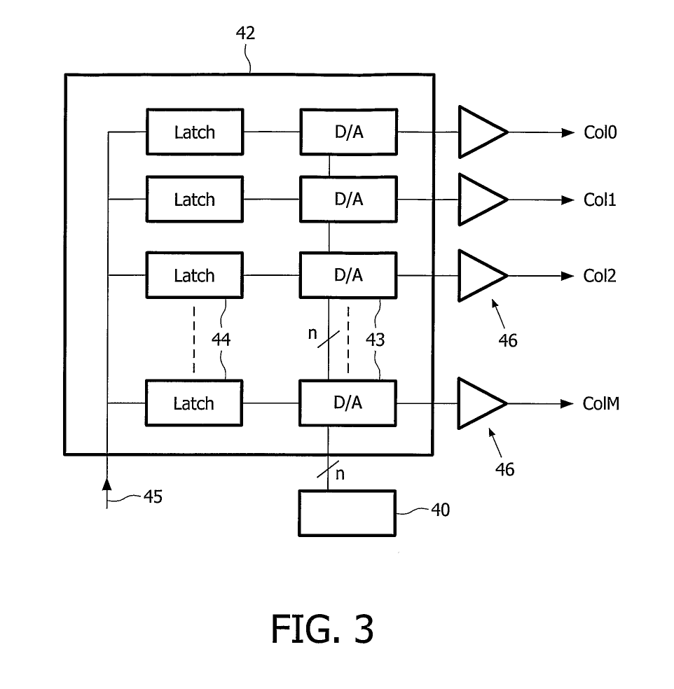

FIG. 3 shows a conventional column driver circuit;

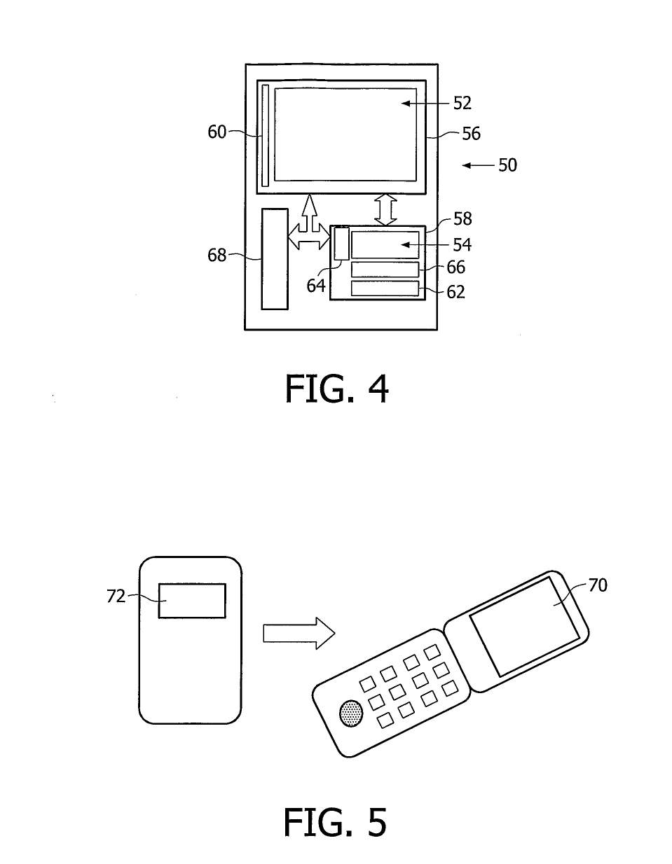

FIG. 4 shows a device of the invention in general form; and

FIG. 5 shows the invention applied to a mobile telephone.

It should be noted that none of the Figures are to scale. Like or corresponding components are generally given the same reference numeral in different Figures.

FIG. 1 shows a conventional pixel configuration for an active matrix liquid crystal display. The display is arranged as an array of pixels in rows and columns. Each row of pixels shares a common row conductor 10, and each column of pixels shares a common column conductor 12. Each pixel comprises a thin film transistor 14 and a liquid crystal cell 16 arranged in series between the column conductor 12 and a common electrode 18. The transistor 14 is switched on and off by a signal provided on the row conductor 10. The row conductor 10 is thus connected to the gate 14a of each transistor 14 of the associated row of pixels. Each pixel additionally comprises a storage capacitor 20 which is connected at one end 22 to the next row electrode, to the preceding row electrode, or to a separate capacitor electrode. This capacitor 20 stores a drive voltage so that a signal is maintained across the liquid crystal cell 16 even after the transistor 14 has been turned off.

In order to drive the liquid crystal cell 16 to a desired voltage to obtain a required grey level, an appropriate analogue signal is provided on the column conductor 12 in synchronism with a row address pulse on the row conductor 10. This row address pulse turns on the thin film transistor 14, thereby allowing the column conductor 12 to charge the liquid crystal cell 16 to the desired voltage, and also to charge the storage capacitor 20 to the same voltage. At the end of the row address pulse, the transistor 14 is turned off, and the storage capacitor 20 maintains a voltage across the cell 16 when other rows are being addressed. The storage capacitor 20 reduces the effect of liquid crystal leakage and reduces the percentage variation in the pixel capacitance caused by the voltage dependency of the liquid crystal cell capacitance.

The rows are addressed sequentially so that all rows are addressed in one frame period, and refreshed in subsequent frame periods.

As shown in FIG. 2, the row address signals are provided by row driver circuitry 30, and the pixel drive signals are provided by column address circuitry 32, to the array 34 of display pixels. The column address circuitry includes digital to analogue converters (DACs) for converting a digital control signal, for example a 6 bit control signal, into an appropriate analogue level for driving a column conductor 12 associated with the DAC.

FIG. 3 shows a conventional column driver circuit. The number n of different pixel drive signal levels are generated by a grey level generator 40, for example a resistor array. A switching matrix 42 controls the switching of the required level to each column and comprises an array of converters 43 for selecting one of the n grey levels based on a digital input from a latch 44. The digital input is derived from a RAM storing the required image data 45. Each column is provided with a buffer 46 for holding a pixel in the column to the required drive signal level for the full duration of the row address period. The column driver circuit also includes timing/control circuitry, not shown in FIG. 3.

The row address circuitry operates to provide a desired row voltage waveform to the rows of pixels in turn. The row address circuitry generally comprises a row voltage generation part, which generates the different row voltage levels which form the basis of the row address signal, timing/control circuitry for generating the row address signal, and a latching circuit which operates to latch the row address signal to the rows of pixels in turn. The row address signal may be a two-level signal, but there are a number of different drive schemes, some of which require multiple level row address signal waveforms. These will be apparent to those skilled in the art.

The frame (field) period for active matrix display devices requires a row of pixels to be addressed in a short period of time, and this in turn imposes a requirement on the current driving capabilities of the active matrix pixel transistor in order to charge or discharge the liquid crystal material to the desired voltage level. In order to meet these current requirements, the gate voltage supplied to the thin film transistor may need to fluctuate between values separated by approximately 30 volts. This requirement needs the row driver circuitry to be implemented using high voltage components. The generation of multiple voltage levels within the row driver circuit is typically achieved using charge pump circuits. These may be considered to be part of the row or column driver circuitry or else they may be provided as separate elements.

The invention relates to electronic devices which include two (or more) array substrates. Devices of this type are becoming increasingly popular. For example, a mobile telephone may be provided with a smaller lower resolution display on an outside casing, which can be viewed with the telephone in a closed position, and a larger higher resolution display may be provided in an inside surface, and which is revealed when the telephone casing is opened up.

FIG. 4 is used to explain the invention generally and shows an electronic device 50 comprising a first array device 52, which will typically be an active matrix array device, and a second array device 54 (which may also be an active matrix array device), each having a pixel array. The pixel array of the first device 52 is provided on a first substrate 56 and the pixel array of the second device 54 is provided on a second, separate, substrate 58.

A part 60 of the circuitry of the first device 52 is provided on the on the first substrate 56, but another part 62 is provided on the second substrate 58. This part 62 may comprise part of the row and/or column driver circuitry, and/or it may comprise other circuit elements providing and/or processing signals associated with the rows and/or columns of pixels.

The control/drive circuitry for the first device 52 is thus distributed over two substrates. This can enable the costs associated with a defect in the row and column driver circuitry to be minimised. As shown in FIG. 4, the second device 54 is smaller (although it may have other different lower performance characteristics) so that the cost associated with a failed second substrate is less than the cost associated with a failed first substrate.

The second device 54 may be smaller, and/or it may have lower resolution and/or it may be black and white instead of colour.

The control circuitry for the second device 54, namely row 64 and column 66 address circuits are provided on the second substrate 58, although there will be additional circuit functions performed by separate external integrated circuits 68. As shown schematically in FIG. 4, there is direct communication of signals between the two substrates, but also between the two substrates and the external circuitry 68.

The first active matrix array device 52 will typically comprise an active matrix display, for example a liquid crystal display or an electroluminescent display. The second active matrix array device may also comprise a display, but it may be an image sensor device or a touch sensing device, such as a fingerprint sensor.

As shown, a part 62 of the row or column driver circuitry of the first device 52 is provided on the second substrate 58. In deciding which circuit functions will be transferred to the second substrate, the complexity of the interconnect between the substrates which would be required is taken into account. The complete row and column addressing circuitry is preferably not transferred because of the large number of signal connections that would be required. It is desirable to lower the complexity of the circuits carried on the first substrate, for example by transferring circuit functions such as digital to analogue converter circuits, charge pump circuits, control or timing circuits and memory circuits. These functions require relatively few connections but may significantly affect the yield of the first device 52.

Latching circuits or multiplexing circuitry (which have large numbers of outputs) may remain on the substrate 56 of the first device 52.

By reducing the complexity of the circuitry on the first substrate 56, the border width can be minimised. This first device will typically be the main full function display of a device, and for hand held devices, it is generally desirable for the display to occupy the maximum possible area. The border area of the second device will generally be less critical, and this area can be increased to accommodate the additional circuitry without compromising the design of the overall device.

The two pixel arrays may be formed using a low temperature polysilicon process, which is suitable for the integration of IC functions. The two pixel arrays may be formed using the same technology, but the technology may instead be optimised differently on the two substrates. For example, a higher performance technology with better design rules and improved TFT characteristics may be applied to the second substrate which carries the more complex circuitry even though this may also carry the array device with the lower performance requirements. For example, the first pixel array may formed using an amorphous silicon process (and which is less suitable for the formation of integrated circuit components) and the second pixel array is formed using a low temperature polysilicon process. Alternatively different types of LTPS process may be used for the two substrates.

FIG. 5 shows how the invention can be applied to a mobile telephone with two displays, a first main display 70 which is visible when a telephone casing is opened, and a smaller subsidiary display 72 which is used when the casing is closed. The main display 70 will have a larger size and better resolution and is used during operations which benefit from a high quality image. The smaller display is used when high information content is not required, such as when the telephone is in a standby mode.

The invention can be applied to devices with two displays, as in the example above, and these displays may be combinations of LCDs, polymer or organic LED display devices. The displays may be active matrix or passive matrix devices or a combination of these. The invention is not, however, limited to multiple display devices, and one or both of the devices may be an image sensing array, a fingerprint sensing array or a touch input device. The second device may also be a passive matrix device.

A device in accordance with the invention may have more than two array devices, and the sharing of circuitry may then be between more than two substrates.

One of the two array devices may be a linear array device (i.e. 1×N), for example a linear scanning array, and the term “array” used in this description and claims is intended to cover the possibility of at least one device being a linear array device.

Other examples will be apparent to those skilled in the art.

1. An electronic device (50), comprising:
a first array device (52) comprising a first pixel array of rows and columns of pixels, and circuitry (60, 62) for providing and/or processing signals associated with the rows and/or columns of pixels; and
a second array device (54) comprising a second pixel array,
wherein the first and second pixel arrays are provided on separate substrates (56,58), wherein a part (62) of the circuitry of the first array device (52) is provided on the substrate (58) of the second pixel array, and wherein the first and second pixel arrays are independently controlled.

2. An electronic device as claimed in claim 1, wherein the first array device (52) comprises an active matrix array device.

3. An electronic device as claimed in claim 2, wherein the first array device (52) comprises an active matrix display.

4. An electronic device as claimed in claim 3, wherein the first array device (52) comprises a liquid crystal display.

5. An electronic device as claimed in claim 1, wherein the second array device (54) comprises an active matrix display.

6. An electronic device as claimed in claim 1, wherein the second array device (54) comprises an image sensor device.

7. An electronic device as claimed in claim 1, wherein the second array device (54) comprises a touch sensing device.

8. An electronic device as claimed in claim 1, wherein the part (62) of the circuitry of the first array device (52) comprises digital to analogue converter circuits.

9. An electronic device as claimed in claim 1, wherein the part (62) of the circuitry of the first array device (52) comprises charge pump circuits.

10. An electronic device as claimed in claim 1, wherein the part (62) of the circuitry of the first array device (52) comprises control or timing circuits.

11. An electronic device as claimed in claim 1, wherein the part (62) of the circuitry of the first array device (52) comprises memory circuit elements.

12. An electronic device as claimed in claim 1, wherein one or both of the first and second pixel arrays are formed using a low temperature polysilicon process.

13. An electronic device as claimed in claim 12, wherein the first pixel array is formed using an amorphous silicon process and the second pixel array is formed using a low temperature polysilicon process.

14. A method of driving a first pixel array device, the first pixel array device (52) being provided on a first substrate (56), the method comprising:
generating control signals for the pixels of the first pixel array device (52);
processing the control signals using circuitry (62) provided on a substrate (58) which carries a second pixel array device (54);
providing the processed control signals to the substrate (56) of the first array device (52); and
controlling the pixels of the first pixel array device (52) using the processed control signals independently of the control of the second pixel array device (54).

15. A method as claimed in claim 14, wherein the first pixel array device (52) comprises an active matrix display.

16. A method as claimed in claim 15, wherein processing the control signals comprises performing digital to analogue conversion.

17. A method as claimed in claim 15, wherein processing the control signals comprises using charge pump circuits.

18. A method as claimed in claim 15, wherein processing the control signals comprises using control or timing circuits.

19. A method as claimed in claim 15, wherein processing the control signals comprises using memory circuit elements.
